(19) United States
(12) Patent Application Publication
(10) Pub. No.: US 2016/0246955 A1
(43) Pub. Date: Aug. 25, 2016

(54) FINGERPRINT ENCODING METHOD AND SYSTEM, AND FINGERPRINT AUTHENTICATING METHOD AND SYSTEM

(71) Applicant: Image Match Design Inc., Hsinchu City (TW)

(72) Inventor: Sun-How JIANG, Hsinchu City (TW)

(21) Appl. No.: 15/047,201

(22) Filed: Feb. 18, 2016

(30) Foreign Application Priority Data
Feb. 24, 2015 (TW) 104105815

(51) Int. Cl. G06F 21/32; G06K 9/00

(52) U.S. Cl. CPC G06F 21/32; G06K 9/00013; G06K 9/00087

(57) ABSTRACT

A fingerprint encoding method shows an alphanumeric character or a symbol offered by a system first. Then, users select a desired finger corresponded with the alphanumeric character or symbol to touch the sensor, thereby acquiring a fingerprint image or a fingerprint characteristic value of the finger to save the fingerprint image or the fingerprint characteristic value in a memory area corresponded with the alphanumeric character or the symbol in a memory. A fingerprint authenticating method does not need to set a preset password, while showing a random verification code offered by the system, and users enter the correspondent fingerprints in order according to the random verification code.

### CROSS-REFERENCE TO RELATED APPLICATIONS

This application claims the priority benefit of Taiwan Application No. 104105815, filed Feb. 24, 2015, the contents of which in its entirety are herein incorporated by reference.

### FIELD OF THE INVENTION

The present invention is related generally to methods and systems for fingerprint encoding and authenticating.

### BACKGROUND OF THE INVENTION

Some network platforms and electronic devices require identification authentication to avoid using by an illegal person. However, there is a trade-off between the safety of the identification authentication and the operational convenience of the identification authentication. The balance point of the trade-off depends on the importance of safety and the operational convenience. A conventional method for authenticating identification asks users to set a password composed by English alphabets and/or numbers. When the input password is correct, users can log in the network platform or start using the electronic devices. The authenticating method using the fixed password is more convenient in operation, but this method is easily deciphered. There is a safer method for authenticating identification by using fingerprint, by which the fingerprint characteristic value of the finger will be detected by a sensor, and when the detected characteristic value and the fingerprint characteristic value saved in a memory are identical, user is approved to log in the network platform or to use the electronic device. There is also a method for authenticating identification by combining aforementioned two authenticating methods. Namely, user has to input a fixed password and verify the characteristic value of the fingerprint.

Chinese Patent Apllication Publication No. CN103646202 discloses an identification authentication method, which encodes fingerprints and combines the fingerprints with numbers. For further details, referring to FIG. 1, different fingerprints of a user's fingers are assigned with different numbers, and a password has to be input by the fingerprints. For example, if the fixed password is 123, the user's right little finger, right thumb, and right middle finger will press a sensor in order. However, if the user loses his/her right little finger or his/her fingerprint of right little finger is broken by accident, the identification authentication will not work. On the other hand, the user will need a complicated process to change the fixed password or encode the fingerprint again. Moreover, every user may use more than one network platforms or electronic devices. For different network platforms, such as his/her online banking accounts or other online trading platforms, the user usually need to set different fixed passwords for identification authentication. As a result, users have to memorize more than one set of passwords, which may be easily confused. Obviously, it is inconvenient for users. Moreover, a user usually only has ten fingers. Thus, the conventional method for encoding fingerprints can only cooperate with the numbers from zero to nine, and the password can be only composed by numbers. Accordingly, the amounts of the password that are able to set are less.

### SUMMARY OF THE INVENTION

An objective of the present invention is to provide a fingerprint encoding method and system which may have more encoding amounts.

Another objective of the present invention is to provide a fingerprint authenticating method and system which requires no password set by users.

According to the present invention, a fingerprint encoding method comprises steps of: selecting an alphanumeric character or a symbol to be encoded; detecting a fingerprint of a finger on a sensor and an angle of the fingerprint to acquire a fingerprint image with angle information or a fingerprint characteristic value with angle information; and saving the fingerprint image with angle information or the fingerprint characteristic value with angle information in a memory area corresponded with the alphanumeric character or the symbol in a memory.

According to the present invention, a fingerprint encoding method comprises steps of: selecting an alphanumeric character or a symbol to be encoded; detecting a fingerprint of a finger on a sensor to acquire a fingerprint image or a fingerprint characteristic value; generating a keyboard information according to an inputted key; and saving the keyboard information and the fingerprint image or the fingerprint characteristic value in a memory area corresponded with the alphanumeric character or the symbol in a memory.

According to the present invention, a fingerprint encoding method comprises steps of: detecting a fingerprint of a finger when a panel being touched by the finger to acquire a fingerprint image or a fingerprint characteristic value, wherein the panel includes several areas, each of which is corresponded with an alphanumeric character or a symbol; detecting an area that the finger touched to generate location information; and saving the location information and the fingerprint image or the fingerprint characteristic value in a memory area corresponded with the alphanumeric character or the symbol corresponded with the area that the finger touched in the memory.

According to the present invention, a fingerprint authenticating method comprises steps of: generating a random verification code; detecting fingerprints of fingers touching a sensor in order, to acquire several first fingerprint images or several first fingerprint characteristic values; reading several second fingerprint images or several second fingerprint characteristic values in order from a memory according to the random verification code; and comparing the several first fingerprint images with the several second fingerprint images or comparing the several first fingerprint characteristic values with the several second fingerprint characteristic values in order, wherein when the several first fingerprint images are identical to the several second fingerprint images or the several first fingerprint characteristic values are identical to the several second fingerprint characteristic values, an authentication will pass.

According to the present invention, a fingerprint authenticating method comprises steps of: generating a random verification code; detecting fingerprints of fingers touching a sensor in order, to acquire several fingerprint images or several fingerprint characteristic values; reading alphanumeric characters or symbols corresponding to the several fingerprint images or the several fingerprint characteristic values in order in a memory according to the several fingerprint images or the several fingerprint characteristic values, thereby generating an input code; and comparing the input code with the random verification code, wherein when the input code and the random verification code are identical, an authentication will pass.

According to the present invention, a fingerprint encoding system comprises a display device configured to display an alphanumeric character or a symbol to be encoded; a sensor configured to detect a fingerprint of a finger and an angle of the fingerprint to generate a fingerprint image with angle information or a fingerprint characteristic value with angle information; a memory; and a memory controller electronically connected to the display device, the sensor, and the memory, and configured to save the fingerprint image with angle information or the fingerprint characteristic value with angle information in a memory area corresponded with the alphanumeric character or the symbol in the memory.

According to the present invention, a fingerprint encoding system comprises: a display device configured to display an alphanumeric character or a symbol to be encoded; a sensor configured to detect a fingerprint of a finger to generate a fingerprint image or a fingerprint characteristic value; a keyboard with several keys configured to generate keyboard information according to a pressed key; a memory; and a memory controller electronically connected to the display device, the sensor, the memory and the keyboard, configured to save the keyboard information and the fingerprint image or the fingerprint characteristic value in a memory area corresponded with the alphanumeric character or the symbol in the memory.

According to the present invention, a fingerprint encoding system comprises: a panel including several areas configured to generate location information according to an area that is touched by a finger, wherein each of the several areas is corresponded with an alphanumeric character or a symbol; a plurality of sensors attached to the panel, configured to detect a fingerprint of the finger to acquire a fingerprint image or a fingerprint characteristic value, wherein each of the plurality of sensor being corresponding to one of the several areas on the panel; a memory; and a memory controller electronically connected to the panel, the sensors, and the memory, configured to save the location information and the fingerprint image or the fingerprint characteristic value in a memory area corresponded with the alphanumeric character or the symbol corresponded with the area that the finger touched in the memory.

According to the present invention, a fingerprint authenticating system comprises: a display device configured to display a random verification code; a sensor configured to detect fingerprints of touched fingers in order, to acquire several first fingerprint images or several first fingerprint characteristic values; a memory; and a memory controller electronically connected to the display device, the sensor, and the memory, and configured to read several second fingerprint images in order from the memory according to the random verification code for being compared with the several first fingerprint images, or read several second fingerprint characteristic values in order from the memory according to the random verification code for being compared with the several first fingerprint characteristic values, wherein when the several first fingerprint images are identical to the several second fingerprint images or the several first fingerprint characteristic values are identical to the several second fingerprint characteristic values, an authentication will pass.

According to the present invention, a fingerprint authenticating system comprises: a display device configured to display a random verification code; a sensor configured to detect fingerprints of touched fingers in order, to acquire several fingerprint images or several fingerprint characteristic values; a memory; and a memory controller configured to read alphanumeric characters or symbols corresponding to the several fingerprint images or the several fingerprint characteristic values in order in a memory according to the several fingerprint images or the several fingerprint characteristic values, thereby generating an input code to compare with the random verification code; wherein when the input code and the random verification code are identical, an authentication will pass.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 shows a corresponding relation between fingerprint images of a user's fingers and numbers;

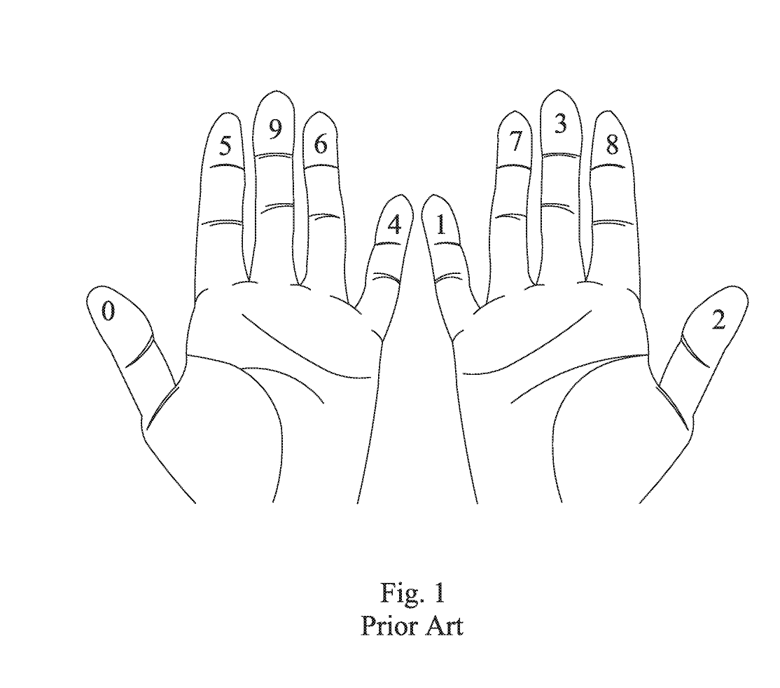

FIG. 2 shows a sensor for detecting fingerprints;

FIG. 3 shows a first embodiment of the present invention for encoding fingerprints;

FIG. 4 shows an embodiment for detecting fingerprints of different angles;

FIG. 5 shows an embodiment of the sensor;

FIG. 6 shows a second embodiment of the present invention for encoding fingerprints;

FIG. 7 shows an another embodiment of the sensor;

FIG. 8 shows a third embodiment of the present invention for encoding fingerprints;

FIG. 9 shows a fourth embodiment of the present invention for encoding fingerprints;

FIG. 10 shows a fifth embodiment of the present invention for encoding fingerprints;

FIG. 11 shows a sixth embodiment of the present invention for encoding fingerprints;

FIG. 12 shows a first embodiment of a fingerprint authenticating method according to the present invention;

FIG. 13 shows a second embodiment of a fingerprint authenticating method according to the present invention;

FIG. 14 shows a third embodiment of a fingerprint authenticating method according to the present invention;

FIG. 15 shows a fourth embodiment of a fingerprint authenticating method according to the present invention; and

FIG. 16 shows an application of a fingerprint authenticating method according to the present invention.

### DETAILED DESCRIPTION OF THE INVENTION

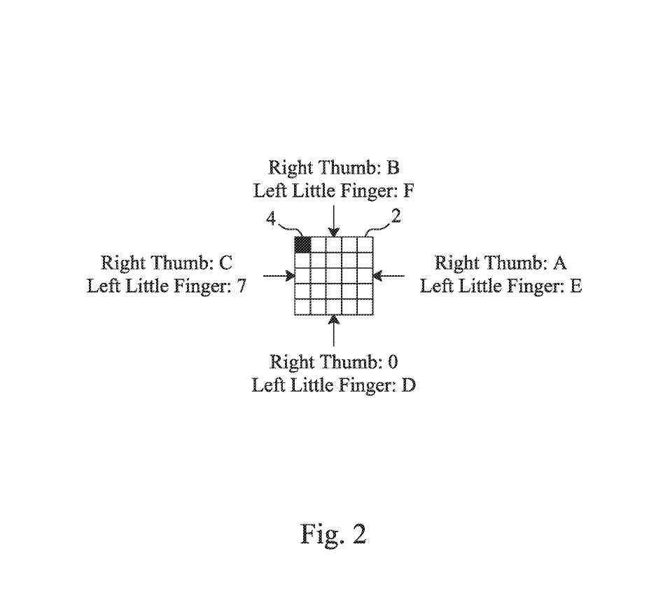

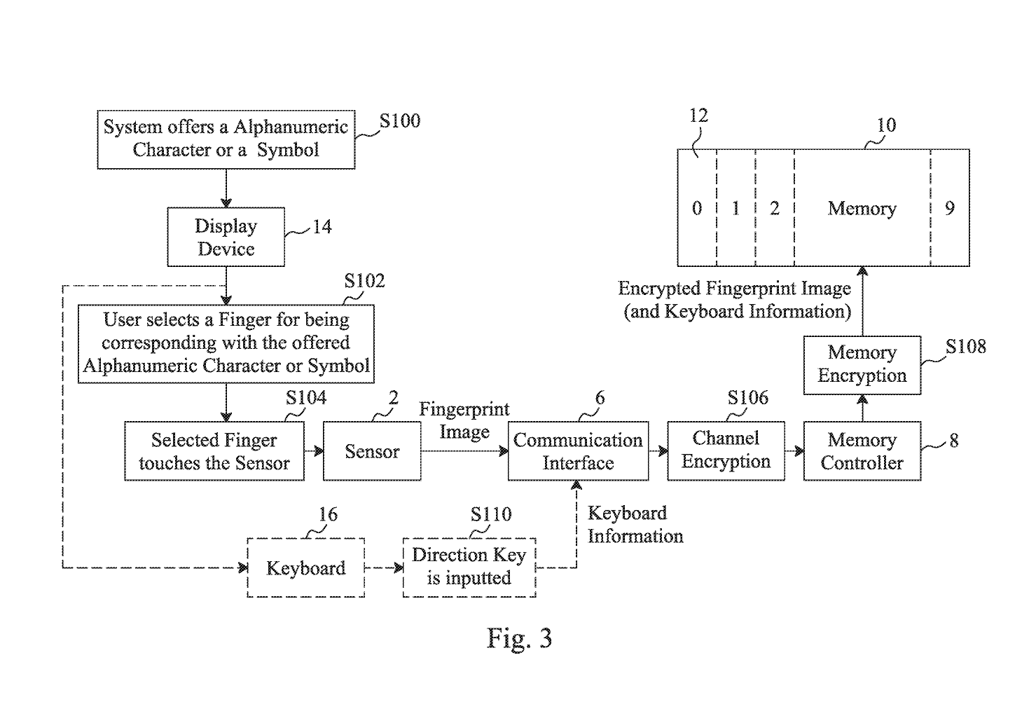

FIG. 2 shows a sensor 2 for detecting fingerprints, which includes a turning datum point 4. FIG. 3 shows a flowchart of a fingerprint encoding method according to the present invention. Referring to FIGS. 2 and 3, while encoding fingerprints as shown by step S100, a system will offer a number or an English alphabet (hereinafter alphanumeric character) or a symbol and display them on a display device 14. The user selects a finger for being corresponded with the offered alphanumeric character or symbol as shown by step S102. Then, referring to step S104, the selected finger touches the sensor 2, which detects the fingerprint of the finger to generate a fingerprint image to a communication interface 6. In step S106, the communication interface 6 executes a channel encryption on the fingerprint image, so that the fingerprint image will be transmitted to a remote memory controller 8. The communication interface 6 can be a signal transmitting-receiving channel installed in the device, or a signal transmitting-receiving channel installed between the devices. A memory controller 8 executes a memory encryption on the fingerprint image and saves the encrypted fingerprint image in a memory area corresponding to the offered alphanumeric character or symbol in a memory 10. That is to say, if the alphanumeric offered by the system is number “0” and the user select the right thumb for being corresponded with the number “0”, then the fingerprint image of the right thumb will be encrypted and saved in the memory area 12 corresponded with the number “0” in the memory 10. In other embodiments, if the sensor 2, the memory controller 8, and the memory 10 are installed in an intranet device, the communication interface 6 can be removed, and the sensor 2 can transmit the fingerprint image to the memory controller 8 directly.

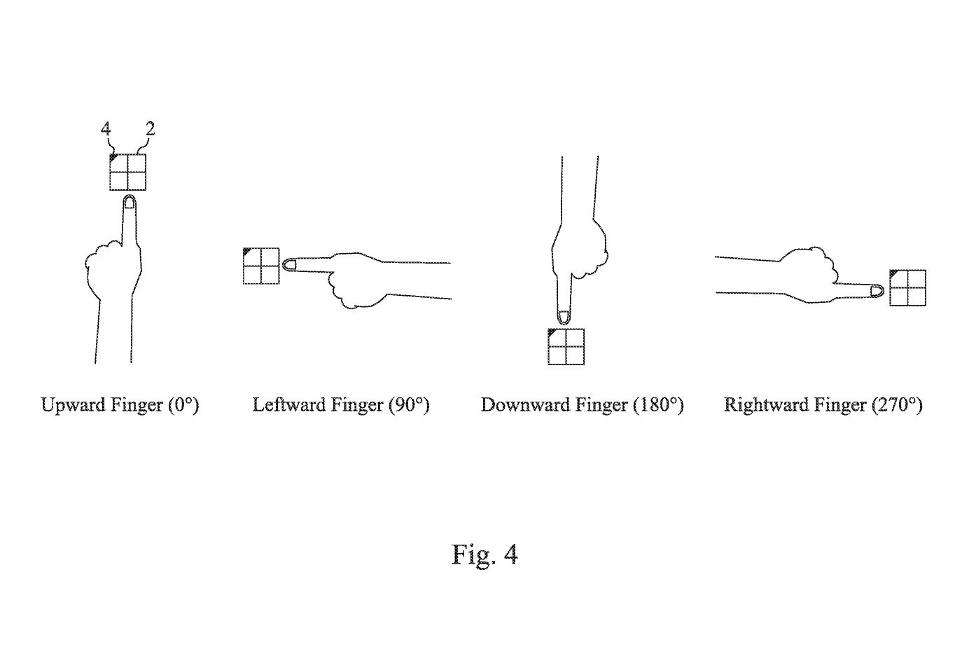

In the flowchart for encoding fingerprints as shown in FIG. 3, an angle of the finger on the sensor 2 can be utilized for setting the corresponding alphanumeric character or symbol. Referring to FIG. 4, the finger can touch the sensor 2 with an angle. In this embodiment, an upward finger represents 0 degrees, a leftward finger represents 90 degrees, a downward finger represents 180 degrees, and a rightward finger represents 270 degrees. The turning datum point 4 on the sensor 2 will identify the direction or the angle. Referring to FIGS. 2 and 4, when the alphanumeric character offered by the system is “0”, the user's right thumb touches the sensor 2 upward. After that, as shown by steps S106 and S108 in FIG. 3, the fingerprint image of the right thumb with the angle of 0 degree will be encrypted and saved in the memory area 12 that is corresponded with the number “0”. When the alphanumeric character offered by the system is “A”, the user's right thumb touches the sensor 2 leftward. After that, as shown by steps S106 and S108 in FIG. 3, the fingerprint image of the right thumb with the angle of 90 degrees will be encrypted and saved in the memory area that is corresponded with the alphabet “A”. In the embodiment of FIG. 4, each fingerprint is corresponded with four different alphanumeric characters according to different angles respectively. As shown by FIG. 2, the 0 degree, the 90 degrees, the 180 degrees, and the 270 degrees of the fingerprint of the right thumb are corresponded with the alphanumeric characters “0”, “A”, “B”, and “C”, respectively. The 0 degree, the 90 degrees, the 180 degrees, and the 270 degrees of the fingerprint of the left little finger are corresponded with the alphanumeric characters “D”, “E”, “F”, and “7”, respectively. Thus, ten fingers are not only sufficient to correspond to all alphanumeric characters but also have surplus that can correspond to other symbols. In the embodiment of FIG. 4, when the fingerprint turns 90 degrees, an alphanumeric character or a symbol will be set accordingly. The turning angle is not limited to 90 degrees. The turning angles can be any angles such as 180 degrees, 120 degrees, 60 degrees, 45 degrees, 30 degrees, 15 degrees, or 1 degree.

The numbers of encoding can be increased not only by changing the directions of the fingers directly but also by the keys of the keyboard such as the direction keys: “↑”, “←”, “↓”, and “→”. Referring to FIG. 3, after the sensor 2 acquires the fingerprint image, the user inputs the direction keys “↑”, “←”, “↓”, of “→” with a keyboard 16, thereby acquiring keyboard information as shown by step S110. Accordingly, the communication interface 6 executes the channel encryption on the fingerprint image and the keyboard information and transmits them to the remote memory controller 8. The memory controller 8 executes the memory encryption on the fingerprint image and the keyboard information, and saves the encrypted fingerprint image and the keyboard information in the memory area corresponded with the alphanumeric character in the memory 10. For example, when the system offers the number “0”, the user touches the sensor 2 with the right thumb to acquire the fingerprint image of the right thumb. After that, the user inputs the direction key “↑”. Accordingly, the fingerprint image of the right thumb and the keyboard information of the direction key “↑” will be encrypted and saved in the memory area 12 corresponded with the number “0” via steps S106 and S108 in FIG. 3. When the system offers the alphanumeric character “A”, the user touches the sensor 2 with the right thumb to acquire the fingerprint image of the right thumb. After that, the user inputs the direction key “←”. Accordingly, the fingerprint image of the right thumb and the keyboard information of the direction key “←” will be encrypted and saved in the memory area corresponded with the alphabet “A” via steps S106 and S108 in FIG. 3. In other embodiments, after the display device 14 displays the alphanumeric character or the symbol, the user can input the direction keys via the keyboard 16 before inputs fingerprints via the steps S102 and S104. In this embodiment, only the direction keys are mentioned as examples, but in other embodiments, other keys on the keyboard can be freely utilized, such as the English alphabet keys, the number keys, or the symbol keys. Moreover, the keyboard 16 can adopt a physical keyboard or a virtual keyboard.

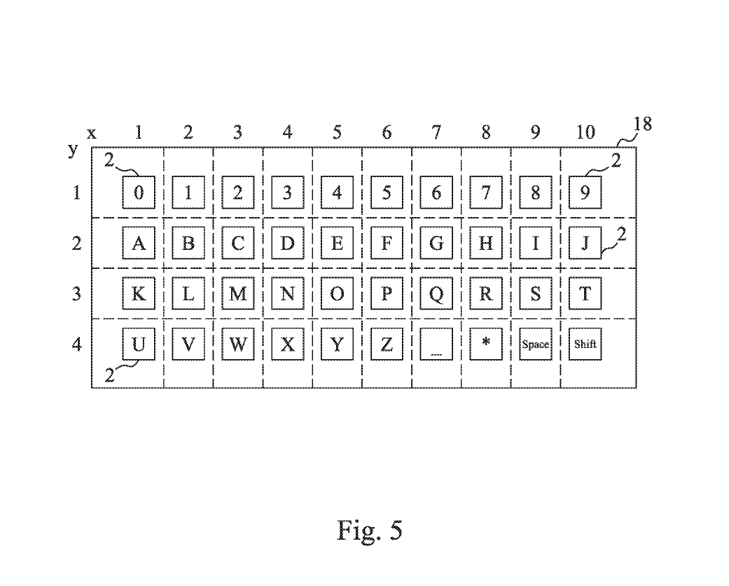

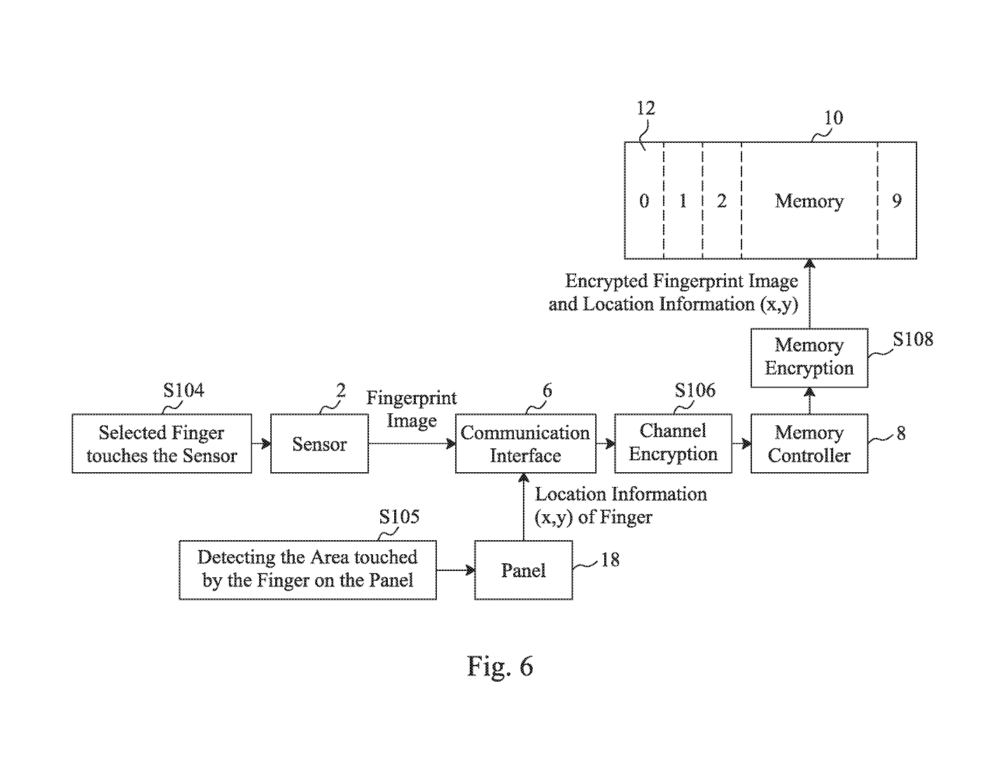

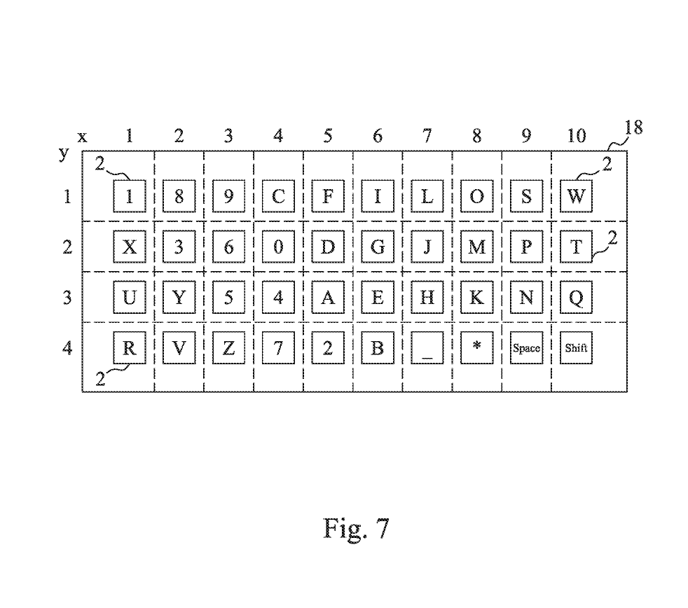

FIG. 5 shows several sensors 2 and a panel 18. There are many areas defined on the panel 18, and each area is corresponded with one alphanumeric character or one symbol, and each area configures one sensor 2. FIG. 6 shows a flowchart of another fingerprint encoding method according to the present invention. Referring to FIGS. 5 and 6, when a user's finger touches the panel 18 as shown in step S104, the sensor 2 will detect the finger and generate the correspondent fingerprint image. Moreover, the panel 18 detects the area that the finger touched to generate location information (x, y) of the finger as shown in step S105. Then, the communication interface 6 executes the channel encryption on the fingerprint image and the location information (x, y) and transmits them to the remote memory controller 8 as shown by step S106. The memory controller 8 executes the memory encryption on the fingerprint image and the location information (x, y) and saves the encrypted fingerprint image and location information (x, y) in the memory area corresponded with the touched alphanumeric character in the memory 10 as shown by step S108. That is to say, if the user's right thumb touches the number “0” on the panel 18, the fingerprint image of the right thumb will be detected and transmitted by the sensor 2. Concurrently, the panel 18 transmits the location information (x1, y1) of the finger. After that, the memory controller 8 executes the encryption on the fingerprint image and location information (x1, y1) of the right thumb and saves them in the memory area 12 corresponded with the number “0” in the memory 10. Similarly, the encoding method in FIG. 6 can also acquire the fingerprints of different angles according to the directions of fingers and encode the fingerprints of different angles. The keys on the panel 18 in FIG. 5 are arranged in number and alphabet orders. In other embodiments, the keys on the panel 18 can be arranged randomly as shown by the panel 18 in FIG. 7. In other embodiments, if the sensor 2, the memory controller 8, and the memory 10 are installed in an intranet device, the communication interface 6 can be removed, and the sensor 2 can transmit the fingerprint image to the memory controller 8 directly.

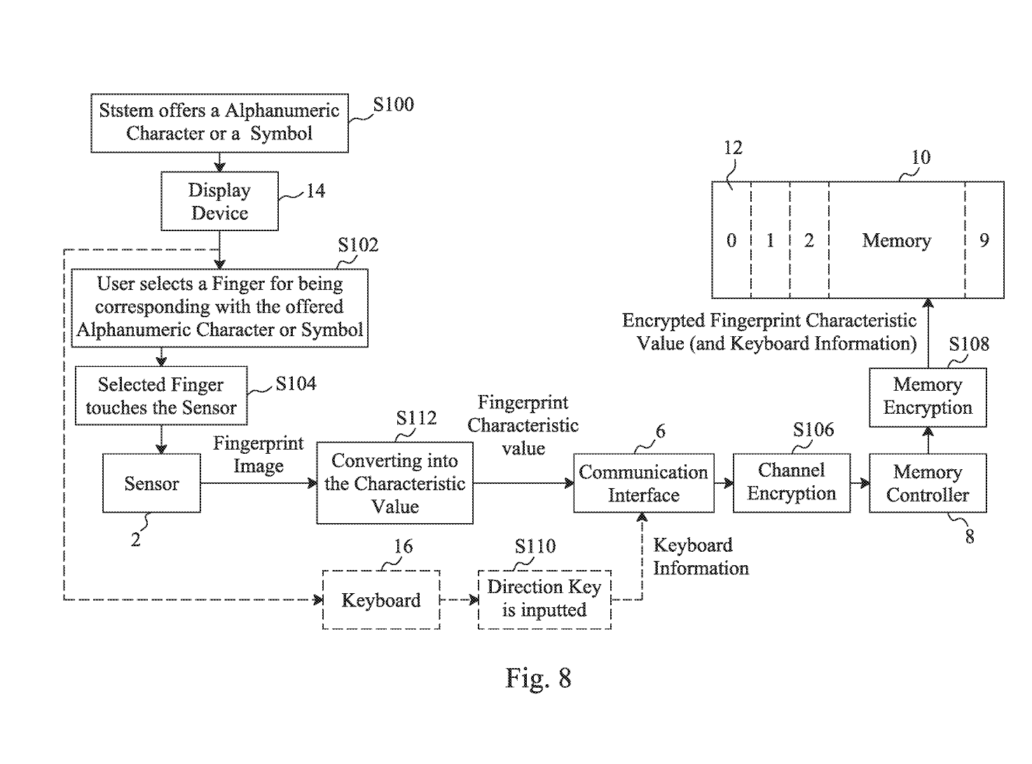

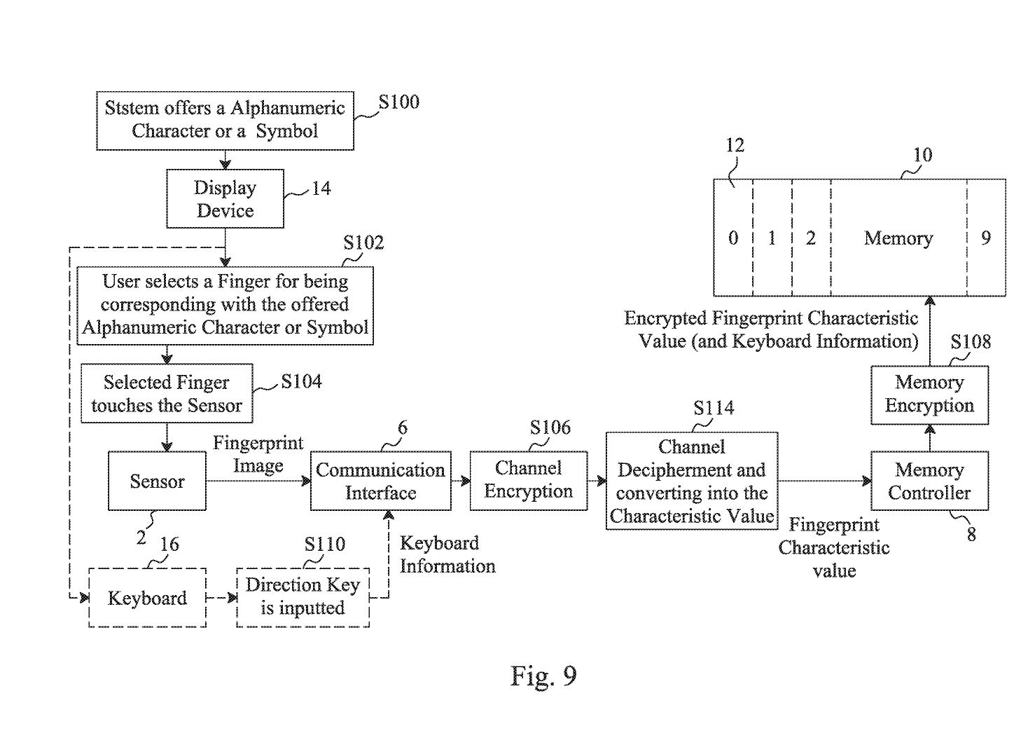

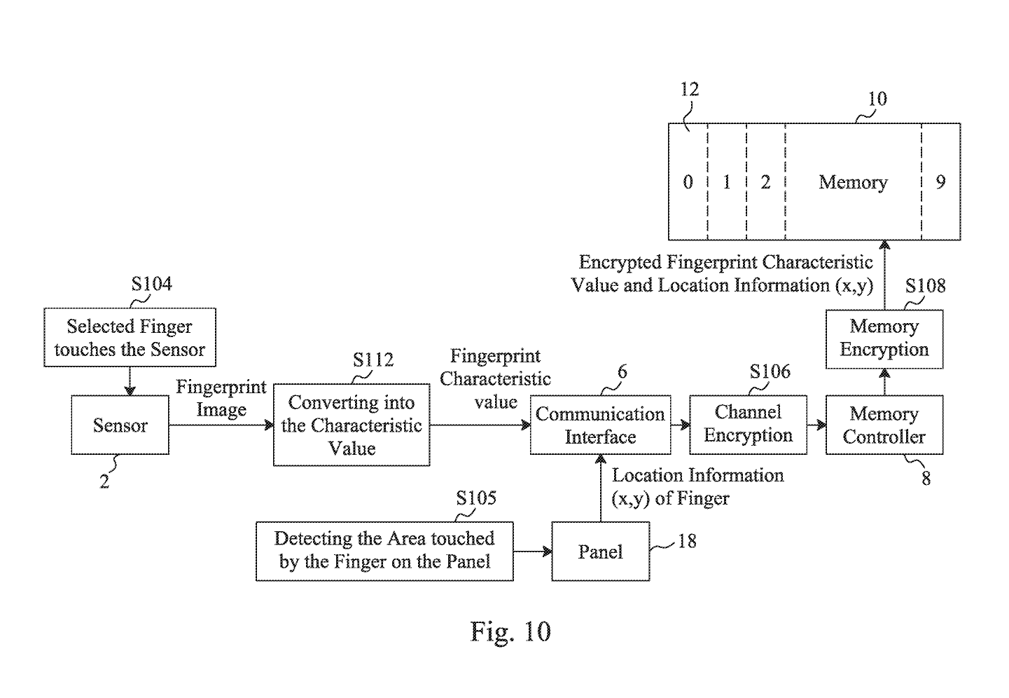

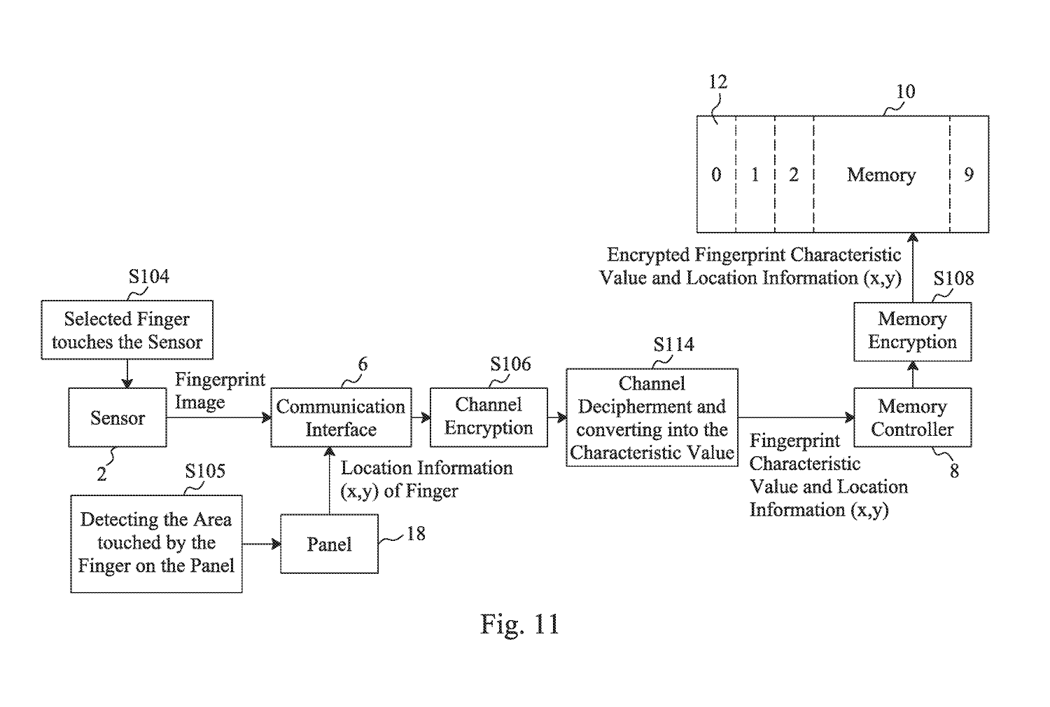

FIG. 8 shows a third embodiment of the present invention. The process in FIG. 8 is almost the same as that in the FIG. 3, while in FIG. 8, after the sensor 2 generates the fingerprint image in step S104, the sensor 2 acquires a fingerprint characteristic value from the fingerprint image in step S112. Then, the communication interface executes the channel encryption on the fingerprint characteristic value and transmits it to the remote memory controller 8. Thereby, the memory controller 8 executes the memory encryption on the fingerprint characteristic value and saves the encrypted fingerprint characteristic value (and keyboard information) in the memory area corresponded with the offered alphanumeric character or symbol in the memory 10. FIG. 9 shows a fourth embodiment of the present invention for encoding fingerprints. The process in FIG. 9 is almost the same as that in the FIG. 3. Differently, in FIG. 9, after step S106, a channel decipherment is executed, and the deciphered fingerprint image will be converted into the fingerprint characteristic value. Accordingly, the fingerprint characteristic value will be transmitted to the memory controller 8, so that the memory controller 8 can execute the memory encryption on the fingerprint characteristic value and save the encrypted fingerprint characteristic value (and keyboard information) in the memory area corresponded with the offered alphanumeric character or symbol in the memory 10. FIG. 10 shows a fifth embodiment of the present invention for encoding fingerprints. The process in FIG. 10 is almost the same as that in FIG. 6. Differently, in FIG. 10, after the sensor 2 generates the fingerprint image in step S104, the sensor 2 acquires the fingerprint characteristic value from the fingerprint image in step S112. Accordingly, the communication interface 6 executes the channel encryption on the fingerprint characteristic value and the location information (x, y) and transmits them to the remote memory controller 8. Thereby, the memory controller 8 executes the memory encryption on the fingerprint characteristic value and the location information (x, y) and saves the encrypted fingerprint characteristic value and the location information (x, y) in the memory area corresponded with the touched alphanumeric character or symbol in the memory 10. FIG. 11 shows a sixth embodiment of the present invention for encoding fingerprints. The process in FIG. 11 is almost the same as that in FIG. 6. Differently, in FIG. 11, after step S106, the remote device executes the channel decipherment and converts the deciphered fingerprint image into the fingerprint characteristic value as shown in step S114. Thereby, the memory controller 8 executes the memory encryption on the fingerprint characteristic value and the location information (x, y) and saves the encrypted fingerprint characteristic value and the location information (x, y) in the memory area corresponded with the touched alphanumeric character or symbol in the memory 10.

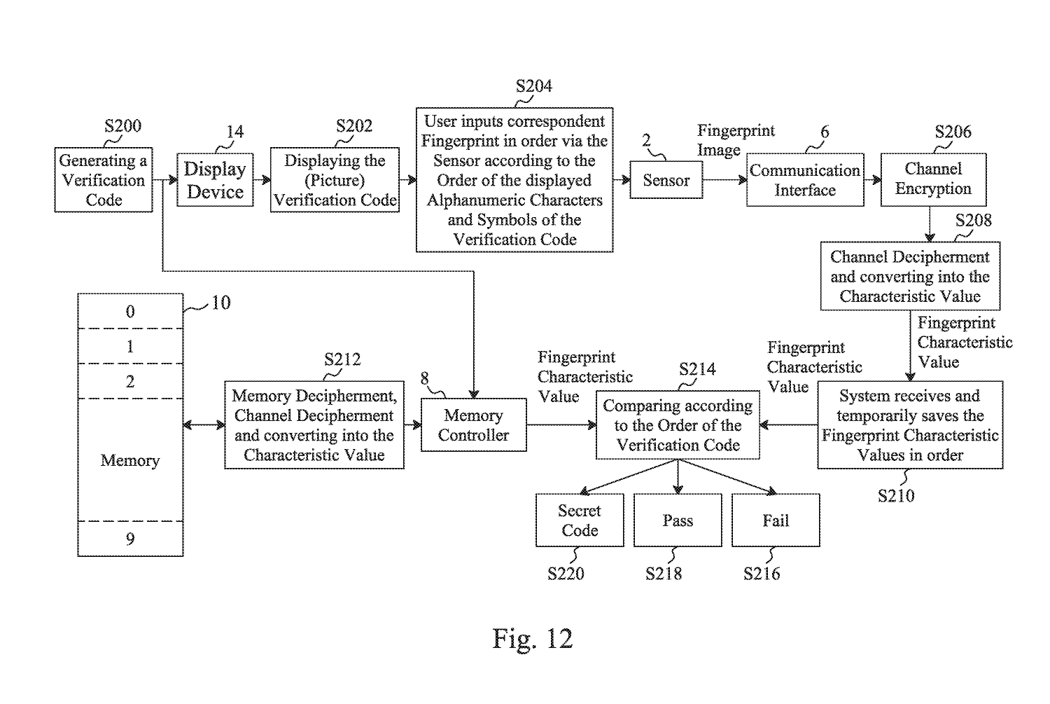

A fingerprint authenticating method of the present invention allows a system to generate a random verification code. Then, the user inputs correspondent fingerprints in order by the sensor 2 according to the random verification code. If the inputted fingerprints and the fingerprints corresponded with the random verification code are identical, an authentication will pass. FIG. 12 is a first embodiment of a fingerprint authenticating method according to the present invention. As shown by step S200, a system generates a set of verification code formed by the random alphanumeric characters and symbols. In step S202, a display device 14 displays the verification code. The user inputs correspondent fingerprints in order via the sensor 2 according to the order of the displayed alphanumeric characters and symbols of the verification code as shown by step S204. The sensor 2 generates fingerprint images after detecting fingerprints of the fingers. Preferably, the sensor 2 further detects the angle of the fingerprints to generate the fingerprint images with angle information. After acquiring the fingerprint images, the communication interface 6 executes channel encryption on the fingerprint images to transmit them to the remote device as shown by step S206. After the remote device receives the encrypted fingerprint images, step S208 will be executed to execute the channel decipherment on the encrypted fingerprint images. Accordingly, the deciphered fingerprint characteristic values of the fingerprint images can be acquired. Then, the system receives and temporarily saves the fingerprint characteristic values in order as shown by step S210. The memory controller 8 reads fingerprint images from the memory 10 in order according to the verification code to execute the memory decipherment and the channel decipherment and converts the deciphered fingerprint images into the fingerprint characteristic values as shown by step S212. In step S214, the fingerprint characteristic values saved in step S210 are compared with the fingerprint characteristic values provided by the memory controller 8 in step S212. If aforementioned fingerprint characteristic values are not identical, step S216 will be executed to judge the identification incorrect, and the authentication will fail. Oppositely, if aforementioned comparison is identical, step S218 will be executed to judge the identification correct, and the authentication will pass. In some circumstances, a set of secret code can be set, and the secret code will not be selected as the verification code. For example, if the secret code is “123”, the system will never generate this set of number “123” as the verification code. The memory controller 8 reads the fingerprint images from the memory 10 in order according to the secret code and executes the memory decipherment as well as the channel decipherment on the read fingerprint images, and then converts the fingerprint images into the fingerprint characteristic values. If the inputted fingerprints conform to the fingerprint characteristic values corresponded with the secret code as shown by step S220, the system will pass the authentication. However, at the same time, a warning will be generated for notifying related safety and protection system or police. In other embodiments, if the sensor 2, the memory controller 8, and the memory 10 are installed in an intranet device, the communication interface 6 can be removed, and step S206 will not be executed, and steps S208 and S212 also need no channel decipherment.

The secret code can be a predetermined fixed password, but this needs the user to set and memorize the secret code so that the load of the user will increase. In order to avoid such problem, the secret code can be the reverse verification code. For example, the number “123456” is set as the verification code. When the user wants to give a warning, he/she can enter “654321”. Oppositely, if the user enters “123456”, an authentication is pass. Wherein, the verification code should not be a repeated set of number or a symmetric set of number such as “33333” or “456654”. Preferably, the secret code can be also generated after subtracting a fixed value from each bit of the verification code or adding the fixed value to each bit of the verification code. This fixed value are set in advance, but it is not a password; this fixed value is not related to the fingerprint encoding. For example, when the verification code is “A32109” and the fixed value is “111111”, the secret code will be generated while the fixed value is subtracted from the verification code and become “Z21098”. When the user wants to give a warning, he/she enters the secret code “Z21098”, so that the system will judge it and trigger the warning. If the fixed value is formed by zeros, for example “000000”, the user only has to enter the same fingerprint for six times no matter what the verification code is. Accordingly, a warning will be triggered according to the confirmation of the system when the sensor detects the same fingerprint information continuously.

The secret code can proceed with the remote data exchange or trading and generate a warning to the related safety and protection system or police at the same time. Thus, the situation that users are forced to use their fingerprint information unwillingly to do the trading can be avoided. Moreover, another set of secret code can be defined for turning off the warning if needed.

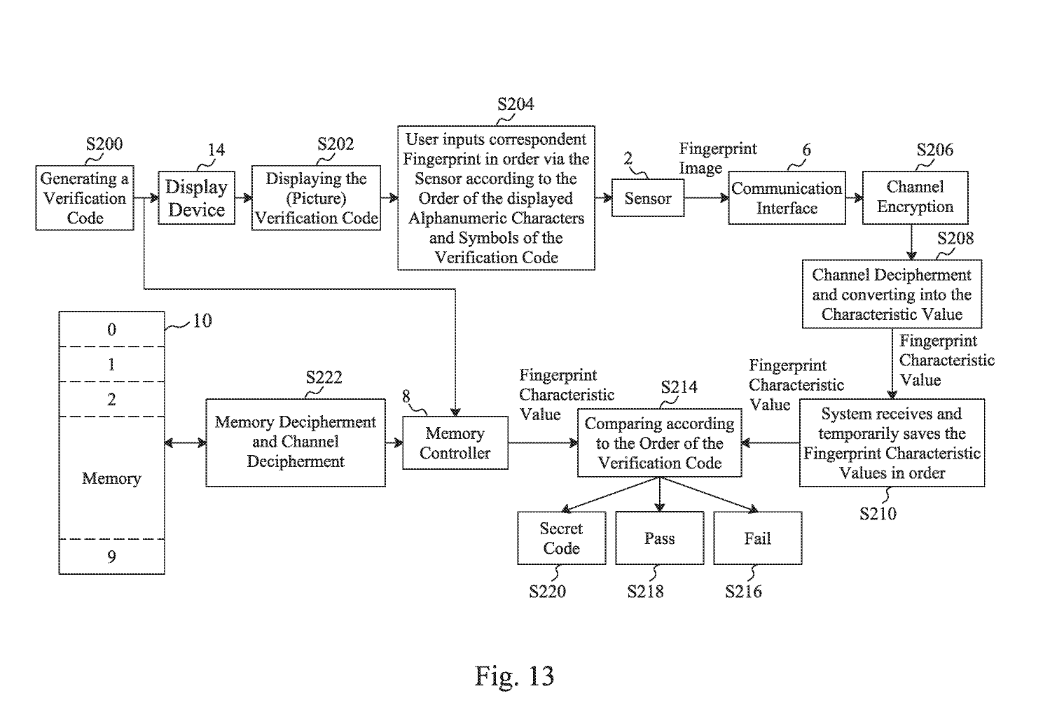

FIG. 13 shows a second embodiment of a fingerprint authenticating method according to the present invention. The process shown in FIG. 13 is almost the same as that shown in FIG. 12. Differently, the memory 10 in FIG. 13 saves the fingerprint characteristic value. Accordingly, after the memory controller 8 reads the fingerprint characteristic values from the memory 10, the memory controller 8 only needs to execute the memory decipherment and the channel decipherment as shown by step S222. No further conversion is needed. In other embodiments, if the sensor 2, the memory controller 8, and the memory 10 are installed in an intranet device, the communication interface 6 can be removed, and step S206 will not be executed, and steps S208 and S222 also need no channel decipherment.

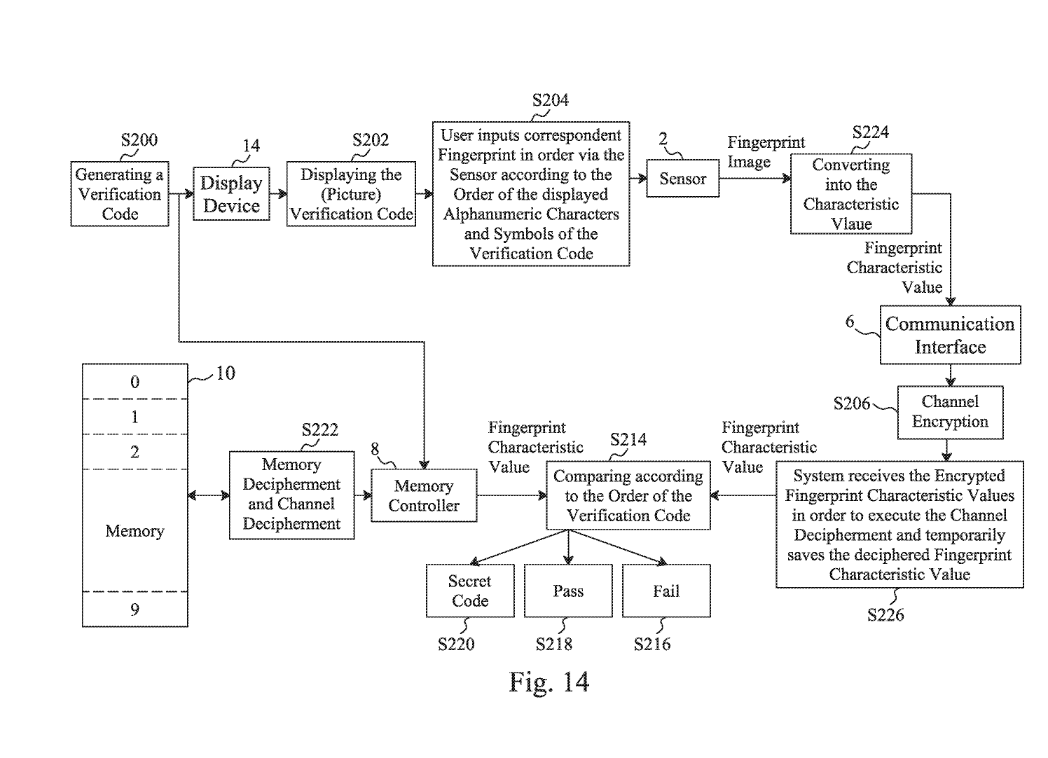

FIG. 14 shows a third embodiment of a fingerprint authenticating method according to the present invention, in which similarly the system generates a set of verification code formed by random alphanumeric characters and symbols as shown by step S200. Then, the display device 14 displays the verification code as shown by step S202. The user inputs correspondent fingerprints in order via the sensor 2 according to the alphanumeric character and the symbol of the verification code as shown by step S204. The sensor 2 detects the fingerprints of fingers to generate fingerprint images. In step S224, the sensor 2 converts the fingerprint images into fingerprint characteristic values. Accordingly, the communication interface 6 executes the channel encryption on the fingerprint characteristic values to transmit them to the remote device as shown by step S206. The system receives the encrypted fingerprint characteristic value in order, to execute the channel decipherment, and the deciphered fingerprint characteristic values will be saved temporarily as shown by step S226. A memory controller 8 reads the fingerprint characteristic values in order from the memory 10 according to the verification code and executes the memory decipherment as well as the channel decipherment as shown by step S222. In other embodiments, if the memory 10 saves the fingerprint images, the fingerprint images have to be converted into the fingerprint characteristic values. In step S214, the fingerprint characteristic values saved by step S226 will be compared with those provided by the memory controller 8. If the comparison is not identical, the identification will be judged incorrect by step S216, and the authentication will fail. If the comparison is identical, the identification will be judged correct by step S218, and the authentication will pass. If the verification code that is entered by the user is incorrect but conforms to the secret code, the system will pass the authentication but generate a warning to notify the related safety and protection system or police at the same time. In other embodiments, if the sensor 2, the memory controller 8, and the memory 10 are installed in an intranet device, the communication interface 6 can be removed, and step S206 will not be executed, and steps S222 and S226 also need no channel decipherment.

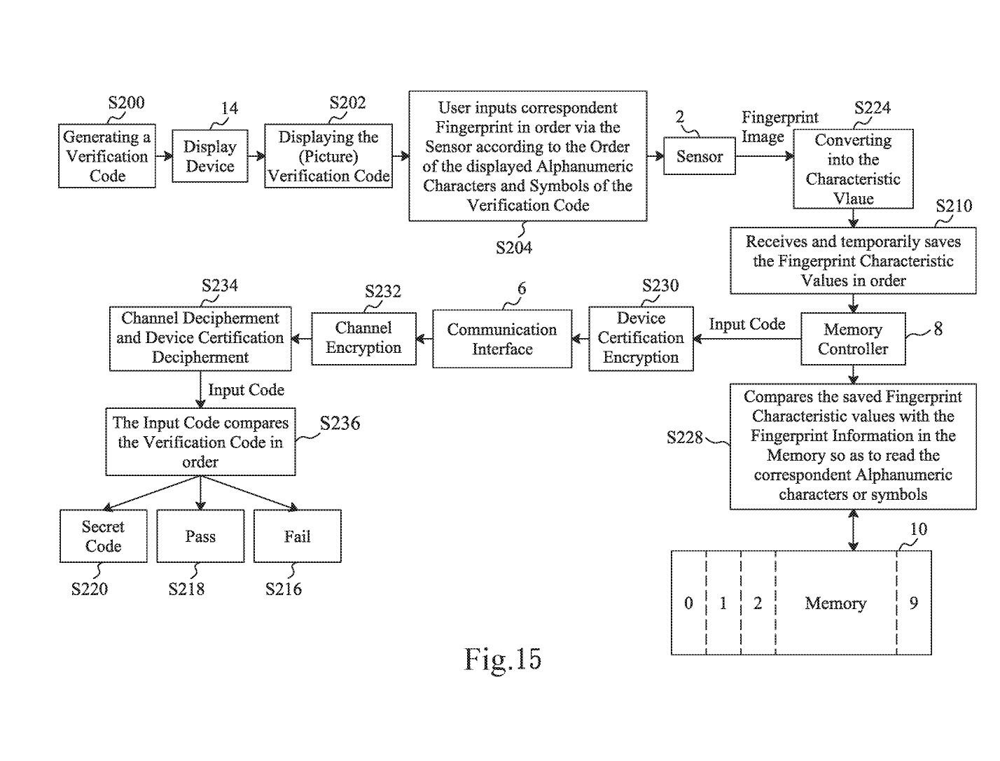

FIG. 15 shows a fourth embodiment of a fingerprint authenticating method according to the present invention, in which similarly the system generates a set of verification code formed by the random alphanumeric characters and symbols as shown by step S200. Then, the display device 14 displays the verification code as shown by step S202. The user inputs correspondent fingerprints in order on the sensor 2 according to the alphanumeric character and the symbol of the verification code as shown by step S204. The sensor 2 detects the fingerprints of fingers to generate fingerprint images as shown. In step S224, the sensor 2 converts the fingerprint images into fingerprint characteristic values. Then, in step S210, the fingerprint characteristic values are received in order and saved temporarily. The memory controller 8 compares the saved fingerprint characteristic values with the fingerprint information in the memory 10 to read the correspondent alphanumeric character or symbol and thereby generate a set of input code as shown by step S228. After that, the input code will be encrypted by a device certification encryption as shown by step S230. Then, the communication interface 6 executes the channel encryption on the input code to transmit the input code to the remote device as shown by step S232. After the remote device receives the encrypted input code, the channel decipherment and the device certification decipherment will be executed on the encrypted input code, thereby acquiring the input code as shown by step S234. In step S236, the input code will be compared with the verification code. If aforementioned comparison is not identical, step S216 will be executed to judge the identification incorrect, and the authentication will fail. If aforementioned comparison is identical, step 218 will be executed to judge the identification correct, and the authentication will pass. If the deciphered input code and the verification code are not identical, but the deciphered input code conforms to the secret code, the system will pass the authentication but generate a warning to notify the related safety and protection system or police at the same time.

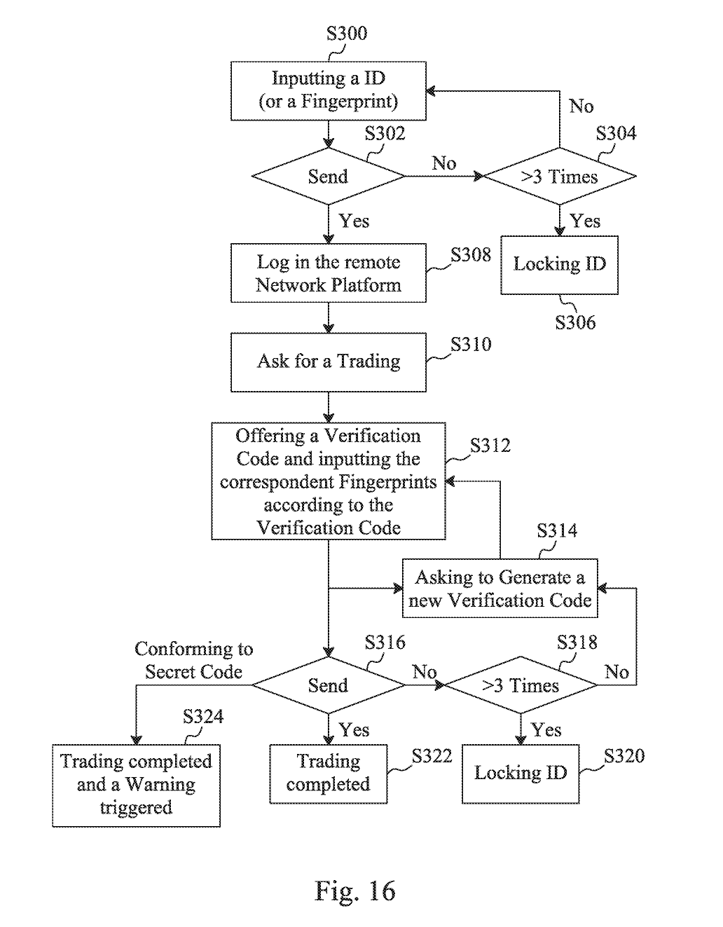

FIG. 16 shows an application of a fingerprint authenticating method according to the present invention. When a user logs in a remote network platform, a preset identification (ID) or fingerprint is needed to input as shown by step S300. After the ID or fingerprint is inputted and sent, the remote network platform identifies whether the ID or fingerprint is correct or not as shown by step S302. If the ID or fingerprint is incorrect, an error time will be counted as shown by step S304. If the error times are lower than a preset value, for example three times, it will return to step S300 and the user can input the ID or fingerprint again. If the error times are higher than the preset value, step S306 will be executed to lock the user. In step S302, if the inputted ID or fingerprint is correct, the user is allowed to log in the remote network platform as shown by step S308. In step S310, the user asks for a trading at the remote network platform, and the network platform will offer a random verification code as shown by step S312. Then, the user inputs the correspondent fingerprints according to the offered verification code. If the verification code is unclear, the user can ask to generate a new verification code as shown by step S314. After inputting the fingerprints, the inputted fingerprints will be sent to verify as shown by step S316. If the inputted fingerprints are not conforming to the verification code, an error time will be counted as shown by step S318. If the error times are lower than a preset value, for example three times, a new verification code will be generated for the user to input his/her fingerprints again as shown by step S314. If the error times are higher than the preset value, the user will be locked as shown by step S320. If the inputted fingerprints conform to the verification code, the trading will be completed as shown by step S322. If the inputted fingerprints are not conforming to the verification code but are conforming to the secret code, the trading will be still completed but a warning will be triggered at the same time as shown by step S324. Obviously, in the fingerprint authenticating method according to the present invention, users don't need to memorize passwords, which is more convenient for users. Moreover, if users lose their fingers or if their fingerprints are broken, a new verification code can be generated for excluding the missing fingers or fingerprints.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A fingerprint encoding method comprising steps of:
A.) selecting an alphanumeric character or a symbol to be encoded;
B.) detecting a fingerprint of a finger on a sensor and an angle of the fingerprint to acquire a fingerprint image with angle information or a fingerprint characteristic value with angle information; and
C.) saving the fingerprint image with angle information or the fingerprint characteristic value with angle information in a memory area corresponded with the alphanumeric character or the symbol in a memory.

2. The fingerprint encoding method of claim 1, further comprising a step of determining the angle of the fingerprint according to a turning datum point of the sensor.

3. A fingerprint encoding method comprising steps of:
A.) selecting an alphanumeric character or a symbol to be encoded;
B.) detecting a fingerprint of a finger touching sensor to acquire a fingerprint image or a fingerprint characteristic value;
C.) generating a keyboard information according to an inputted key; and
D.) saving the keyboard information and the fingerprint image or the fingerprint characteristic value in a memory area corresponded with the alphanumeric character or the symbol in a memory.

4. A fingerprint encoding method comprising steps of:
A.) detecting a fingerprint of a finger when a panel is touched by the finger to acquire a fingerprint image or a fingerprint characteristic value, wherein the panel includes several areas and each of the several areas is corresponded with an alphanumeric character or a symbol;
B.) detecting an area that the finger touched to generate location information; and
C.) saving the location information and the fingerprint image or the fingerprint characteristic value in a memory area corresponded with the alphanumeric character or the symbol corresponded with the area that the finger touched in the memory.

5. The fingerprint encoding method of claim 4, wherein the step A comprises detecting an angle of the fingerprint so that the fingerprint image or the fingerprint characteristic value may carry angle information.

6. A fingerprint authenticating method comprising steps of:
A.) generating a random verification code;
B.) detecting fingerprints of fingers touching a sensor in order, to acquire several first fingerprint images or several first fingerprint characteristic values;
C.) reading several second fingerprint images or several second fingerprint characteristic values in order from a memory according to the random verification code; and
D.) comparing the several first fingerprint images with the several second fingerprint images or comparing the several first fingerprint characteristic values with the several second fingerprint characteristic values in order, wherein when the several first fingerprint images is identical to the several second fingerprint images or the several first fingerprint characteristic values is identical to the several second fingerprint characteristic values, an authentication will pass.

7. The fingerprint authenticating method of claim 6, further comprising steps of:
E.) reading several third fingerprint images or several third fingerprint characteristic values in order from the memory according to a secret code; and
F.) comparing the several first fingerprint images with the several third fingerprint images or comparing the several first fingerprint characteristic values with the several third fingerprint characteristic values in order, wherein when the several first fingerprint images is identical to the several third fingerprint images or the several first fingerprint characteristic values is identical to the several third fingerprint characteristic values, a warning will be generated to notify a related safety and protection system or police.

8. The fingerprint authenticating method of claim 7, further comprising a step of generating the secret code by reversing the order of alphanumeric characters and symbols in the random verification code.

9. The fingerprint authenticating method of claim 7, further comprising a step of generating the secret code by subtracting a fixed value from the random verification code or adding the fixed value to the random verification code.

10. The fingerprint authenticating method of claim 6, further comprising a step of generating a warning when the first fingerprint images or the first fingerprint characteristic values are the same to notify a related safety and protection system or police.

11. A fingerprint authenticating method comprising steps of:
A.) generating a random verification code;
B.) detecting fingerprints of fingers touching a sensor in order, to acquire several fingerprint images or several fingerprint characteristic values;
C.) reading alphanumeric characters or symbols corresponding to the several fingerprint images or the several fingerprint characteristic values in order in a memory according to the several fingerprint images or the several fingerprint characteristic values, thereby generating an input code; and
D.) comparing the input code with the random verification code, wherein when the input code and the random verification code are identical, an authentication will pass.

12. The fingerprint authenticating method of claim 11, further comprising steps of:
comparing the input code with a preset secret code; and
generating a warning to notify a related safety and protection system or police when the input code and the secret code are identical.

13. The fingerprint authenticating method of claim 11, further comprising steps of:
generating a secret code by reversing the order of the alphanumeric character and the symbol in the random verification code; and
comparing the input code and the secret code, wherein when the input code and a secret code are identical, a warning will be generated to notify a related safety and protection system or police.

14. The fingerprint authenticating method of claim 11, further comprising steps of:
generating a secret code by subtracting a fixed value from the random verification code or adding the fixed value to the random verification code; and
comparing the input code and the secret code, wherein when the input code and the secret code are identical, a warning will be generated to notify a related safety and protection system or police.

15. The fingerprint authenticating method of claim 11, further comprising a step of generating a warning to notify a related safety and protection system or police when the input code is composed of the same alphanumeric character or the same symbol.

16. A fingerprint encoding system comprising:
a display device configured to display an alphanumeric character or a symbol to be encoded;
a sensor configured to detect a fingerprint of a finger and an angle of the fingerprint to generate a fingerprint image with angle information or a fingerprint characteristic value with angle information;
a memory; and
a memory controller electronically connected to the display device, the sensor, and the memory, configured to save the fingerprint image with angle information or the fingerprint characteristic value with angle information in a memory area corresponded with the alphanumeric character or the symbol in the memory.

17. The fingerprint encoding system of claim 16, wherein the sensor comprises a turning datum point for determining the angle of the fingerprint.

18. A fingerprint encoding system comprising:
a display device configured to display an alphanumeric character or a symbol to be encoded;
a sensor configured to detect a fingerprint of a finger to generate a fingerprint image or a fingerprint characteristic value;
a keyboard with several keys configured to generate keyboard information according to a pressed key;
a memory; and
a memory controller electronically connected to the display device, the sensor, the memory and the keyboard, configured to save the keyboard information and the fingerprint image or the fingerprint characteristic value in a memory area corresponded with the alphanumeric character or the symbol in the memory.

19. A fingerprint encoding system comprising:
a panel having several areas configured to generate location information according to an area that is touched by a finger, wherein each of the several areas is corresponded with an alphanumeric character or a symbol;
a plurality of sensors attached to the panel, configured to detect a fingerprint of the finger to acquire a fingerprint image or a fingerprint characteristic value, wherein each of the plurality of sensors is corresponding to one of the several areas on the panel;
a memory; and
a memory controller electronically connected to the panel, the sensors, and the memory, configured to save the location information and the fingerprint image or the fingerprint characteristic value in a memory area corresponded with the alphanumeric character or the symbol corresponded with the area that the finger touched in the memory.

20. The fingerprint encoding system of claim 19, wherein the plurality of sensors detect an angle of the fingerprint, so that the fingerprint image or the fingerprint characteristic value includes angle information.

21. A fingerprint authenticating system comprising:
a display device configured to display a random verification code;
a sensor configured to detect fingerprints of touched fingers in order, to acquire several first fingerprint images or several first fingerprint characteristic values;
a memory; and
a memory controller electronically connected to the display device, the sensor, and the memory, configured to read several second fingerprint images in order from the memory according to the random verification code for being compared with the several first fingerprint images, or read several second fingerprint characteristic values in order from the memory according to the random verification code for being compared with the several first fingerprint characteristic values, wherein when the several first fingerprint images are identical to the several second fingerprint images or the several first fingerprint characteristic values are identical to the several second fingerprint characteristic values, an authentication will pass.

22. The fingerprint authenticating system of claim 21, wherein the memory controller reads several third fingerprint images in order from the memory according to a secret code for being compared with the several first fingerprint images, or reads several third fingerprint characteristic values in order from the memory according to the secret code for being compared with the several first fingerprint characteristic values, wherein when the several first fingerprint images are identical to the several third fingerprint images or the several first fingerprint characteristic values are identical to the several third fingerprint characteristic values, a warning will be generated to notify a related safety and protection system or police.

23. The fingerprint authenticating system of claim 22, wherein the secret code is generated by reversing the order of the alphanumeric character and the symbol in the random verification code.

24. The fingerprint authenticating system of claim 22, wherein the secret code is generated by subtracting a fixed value from the random verification code or adding the fixed value to the random verification code.

25. The fingerprint authenticating system of claim 21, wherein when the first fingerprint images or the first fingerprint characteristic values are the same, a warning will be generated to notify a related safety and protection system or police.

26. A fingerprint authenticating system comprising:
a display device configured to display a random verification code;
a sensor configured to detect fingerprints of touched fingers in order, to acquire several fingerprint images or several fingerprint characteristic values;
a memory; and
a memory controller configured to read alphanumeric characters or symbols corresponding to the several fingerprint images or the several fingerprint characteristic values in order in a memory according to the several fingerprint images or the several fingerprint characteristic values, thereby generating an input code to compare with the random verification code; wherein when the input code and the random verification code are identical, an authentication will pass.

27. The fingerprint authenticating system of claim 26, wherein when the input code and a secret code are identical, a warning will be generated to notify a related safety and protection system or police.

28. The fingerprint authenticating system of claim 27, wherein the secret code is generated by reversing the order of the alphanumeric character and the symbol in the random verification code.

29. The fingerprint authenticating system of claim 27, wherein the secret code is generated by subtracting a fixed value from the random verification code or adding the fixed value to the random verification code.

30. The fingerprint authenticating system of claim 26, wherein when the input code is composed of the same alphanumeric character or the same symbol, a warning will be generated to notify a related safety and protection system or police.
